(19) United States
(12) Patent Application Publication
(10) Pub. No.: US 2024/0336045 A1
(43) Pub. Date: Oct. 10, 2024

(54) Multilayer Biodegradable Film Obtained by Reactive Co-Extrusion

(71) Applicant: Lam'On LTD, Sofia (BG)

(72) Inventor: Filip Spasov Ublekov, Pazardzhik (BG)

(21) Appl. No.: 18/696,105

(22) PCT Filed: Feb. 17, 2022
(86) PCT No.: PCT/BG2022/050001

§ 371 Date: Mar. 27, 2024

(30) Foreign Application Priority Data
Oct. 7, 2021 (BG) 5391

(51) Int. Cl. B32B 27/08; B29C 48/00; B29C 48/21; B29C 48/88; B29K 33/00; B29K 67/00; B29K 77/00; B29K 105/00; B29L 9/00; B32B 27/30; B32B 27/34; B32B 27/36; B32B 27/38; C08L 67/04

(52) U.S. Cl. CPC B32B 27/08; B32B 27/302; B32B 27/308; B32B 27/34; B32B 27/36; B32B 27/38; C08L 67/04; B29C 48/0018; B29C 48/022; B29C 48/21; B29C 48/9115; B29K 2033/00; B29K 2067/046; B29K 2077/00; B29K 2105/0085; B29K 2995/0041; B29K 2995/0077; B29K 2995/0097; B29L 2009/00; B32B 2250/24; B32B 2270/00; B32B 2307/702; B32B 2307/7163; B32B 2307/7376; C08L 2201/06; C08L 2203/16; C08L 2205/03

(57) ABSTRACT

A multilayer biodegradable film is based on polylactides (polylactic acid), preferably obtained by reactive coextrusion, and may include at least one first layer A and at least one second layer B, in which the layer A and layer B are different from each other and the layer A includes: i) a minimum of 75 wt. % amorphous polylactic acid (PLA) with D isomer content ≥5%; and ii) triblock epoxy styrene-acrylate copolymer up to 5 wt. % of the total polylactic acid in this layer; and layer B includes: i) a minimum of 75 wt. % semi-crystalline polylactic acid with a degree of crystallinity ≥20% and low content of D isomer ≤5%; and ii) triblock epoxy styrene-acrylate copolymer up to 5 wt. % of the total polylactic acid in this layer. The multilayer biodegradable film may be three-layered and obtained by the blown extrusion method.

### CROSS-REFERENCE TO RELATED APPLICATIONS

This application is a national phase application of International Application PCT/BG2022/050001, filed Feb. 17, 2022, which in turn claims priority to Bulgarian patent application serial no. 5391, filed on Oct. 7, 2021; all of which are incorporated by reference herein in their entirety.

### FIELD OF THE INVENTION

The invention relates to a biodegradable film, with and without an adhesive layer, based on polylactides (polylactic acid) and a method for its production by reactive coextrusion. Depending on the composition of the layers, the biodegradable film can be used for hot lamination of different types of paper, aluminum foil or other films based on polyethylene, polypropylene, polyethylene terephthalate, etc., as well as the production of disposable products such as packaging, including food products, waste bags, shopping bags, and sealing materials.

### BACKGROUND OF THE INVENTION

Polymers such as polyethylene and polypropylene have long been used in the manufacturing of packaging film in various industries. Flexible films are usually composed of multiple layers, which include different types of materials to provide the desired functionality, such as flexibility, sealing, barrier properties and printing. For example, in food packaging, the flexible packaging material is often used as a food preservative. Flexible packaging is also used to store various consumer products.

Over the last 20 years, polylactic acid (PLA) has become the leading biodegradable/compostable polymer for plastics and fibers. This is because, albeit PLA comes from natural and renewable resources, it is also thermoplastic and can be extruded by melting to produce plastic products, fibers and non-woven films with good mechanical strength and ductility compared to synthetic materials based on petroleum such as polyolefins (polyethylene and polypropylene) and polyesters (polyethylene terephthalate and polybutylene terephthalate). PLA has similar properties as polyethylene and is used to make a variety of products, such as films, shopping bags, etc. The production of PLA saves 2/3 of the energy required for the production of conventional polymers. It emits 70% fewer greenhouse gases when it decomposes in landfills. The main advantage of biopolymers is that they degrade into substances that do not pollute the environment.

Extrusion is one of the most promising methods for plastic processing. Almost all types of thermoplastic plastics, including polylactic acid, are processed by this method. The products produced in this way can be pipes, profiles, sheets or thin films. The machines on which the process takes place are called extruders. Depending on the plastic material, different types of screws are used with different shapes and different ratios of the three zones—tension zone, shrinkage zone and homogenization zone. The screws have a constant or variable magnitude of the step and channel depth. The sealing of the material is done at the expense of reducing the step and depth of the channel. The ratio of the length of the screw to its diameter determines its ability to homogenize. A typical feature of the extrusion of polylactic acid is the ratio to be greater than 24. Most extruders manufactured after the year 2000 have an equal or greater ratio. This allows the extrusion of polylactic acid on virtually any extruder manufactured after the year 2000.

Extrusion is the most common method of producing plastic films. Polylactic acid films can be obtained by two methods:
1. Direct extrusion through a die ring with subsequent inflation with a certain volume of air to obtain the required thickness.
2. Direct extrusion through a flat die followed by rolling with polished metal cooled rolls.

The first method has found the widest application. From the extruder, the molten plastic enters the die and it is distributed by the mandrel in an even thin layer and comes out in the form of a hot bubble. Compressed air is supplied through the mandrel, which inflates the bubble to the desired thickness of the film and at the same time cools it. The bubble is wound paired and guided by the nip rollers that continuously pull it at a constant speed. At the same time, the nip rollers perform the role of tightly pressing the bubble and preventing the inflating air from escaping. With this technology single-layer and multi-layer films can be produced at the same time. The film obtained by this method has an almost uniformly oriented structure longitudinally and transversely to the pull, which provides virtually the same properties in both directions. At the same time the film is characterized by some darkening due to the increased crystallization due to the delayed cooling.

Another disadvantage of the blown film die ring extrusion method is the limitation of the plastics used, which must have relatively low values for their melt index equal to or less than 12 g/min at 190° C. This limitation is constructively related to the method of blown film die ring extrusion and subsequent bubble blowing. Plastics that do not meet these conditions (they are too fluid in molten state) are extruded through a flat die. Basically, this method extrudes polyolefin—polyethylene, polypropylene, or their copolymers.

Flat die extrusion consists of extruding a melt through a flat die while the melt is lowered vertically and directed toward a cooling device. By cooling the surface of polished metal cooled rolls. With this technology single-layer or multi-layer films can be produced. The film obtained by this method has good optical properties, but the mechanical properties in the two directions differ significantly. The method allows extrusion of films of polyolefins, polyesters, polyvinyl chloride and others.

To date, the production of polylactic acid films is carried out mainly by flat die extrusion, due to the high values of the melt index of polylactic acid, which is between 18 and 22 g/min at 190° C. Up until now, no manufacturer of polylactic acid worldwide has been able to reduce the fluidity of polylactic acid to make it suitable for blown film die ring extrusion. All manufacturers advise their customers to use flat die extrusion—see, for example, the “Ingeo™ Biopolymer 4032D Technical Data Sheet” of NatureWorks LLC of Minnetonka, Minnesota:

https://www.natureworksllc.com/˜/media/Technical_Resources/Technical Data Sheets/Tech nicalDataSheet_4032D_films_pdf.pdf

However, film compositions and methods for their production by blown film die ring co-extrusion including polylactic acid (PLA), are known.

Patent issued in China with No. CN109177401, which is part of the prior art, discloses a completely biodegradable film and its method of production by the blown extrusion method. The completely degradable film consists of three layers—inner, middle and outer layer, arranged sequentially.

The inner layer comprises 10-25 parts polylactic acid PLA, 61.8-68.95 parts poly[butylene terephthalate-co-polybutylene glycol) terephthalate], 0.1-2 parts of a compatibilizer, 0.1 weight parts of a plasticizer, 0.1-3 parts of a nucleating agent, 0.05-0.2 parts of a chain extender, 0.1-1 part of an opening agent, 0.1-2 parts of a lubricant and 0.2-2 parts of black carbon. The middle layer comprises 10-25 parts of polylactic acid, 52.8-83.25 parts of poly[butylene terephthalate-co-polybutylene glycol) terephthalate], 0.1-2 parts of compatibilizer, 0.1-5 parts of plasticizer, 0.1-2 parts of lubricant, 0.05-0.2 part of chain extender and 6-12 parts of titanium dioxide. The outer layer comprises 15-30 parts of polylactic acid, 53.8-82.65 parts of parts poly[butylene terephthalate-co-polybutylene glycol) terephthalate], 0.1-2 parts of a compatibilizer, 0.1-5 parts of a plasticizer, 0.1-2 parts of a lubricant, 0.02-0.2 part of a chain extender and 2-6 parts of titanium dioxide. Each of the three layers additionally comprises glycerol monooctadecanoate, acetyl tributyl citrate, ethylene bisteramide and a chain extender. The anti-blocking agent is erucylamide or oleamide and the chain extender is a triblock copolymer of styrene-acrylate-propylene oxide methacrylate and/or a triblock copolymer of styrene-maleic anhydride-propylene oxide methacrylate. The method for the production of the biodegradable film comprises the following stages: preparation of the composition of each of the layers and its supply to three separate extruders in a blown extrusion line; extrusion and granulation of each layer in a certain temperature profile in zones; simultaneous extrusion of the three layers by the method of blown extrusion; and withdrawing the resulting bubble of the film to produce a fully degradable film.

Document CN105416797, which is also part of the prior art, discloses a biodegradable express delivery packaging composed of a composite layer comprising a first layer, a third layer and a second layer located between the first and third layers. All layers are made of film material A or film material B, wherein film material A consists of the following components by weight %: 95.5% polylactic acid, 3% degradable color masterbatch and 1.5% adhesive, and film material B consists of 95% polyadipic acid/PBT, 3.5% degradable color masterbatch and 1.5% adhesive. The invention further discloses a three-layer co-extrusion technology by the method of blown extrusion of biodegradable express delivery packaging.

The disadvantages of these disclosures are that the PLA used is in a very small ratio, i.e. they are not based on PLA and are not based entirely on renewable sources such as polylactic acid. Copolyesters of adipic acid with 1,4 butanediol, terephthalic acid, dimethyl terephthalic acid and others are completely biodegradable, but the starting monomers are obtained synthetically from non-renewable sources as opposed to PLA.

EP 1 793 994 B1 discloses a PLA-based film obtained by the blown extrusion method, as well as a method for its production by blown extrusion. That method for producing a film by blown extrusion from polylactic acid (PLA) includes:
a) providing dry granules of PLA;
b) melting the granules to form a molten mass of a first desired viscosity value or range of values;
c) increasing the viscosity of the molten mass to a second desired viscosity value or range of values;
d) forming a bubble from the resulting molten mass; and
e) flattening the bubble to form a film, wherein the plasticizer is lactide and the blown PLA film comprises less than 10% of the plasticizer.

A PLA film obtained by this method is also disclosed. Although the disclosed film and the method for its production are based on PLA, they also contain plasticizers, which reduce the glass transition temperature of the PLA and severely limit the temperature range of application of the products.

Document WO 2009/152427 A1 (TORAY PLASTICS AMERICA INC [US]; LEE MARK D [US] ET AL., 17 Dec. 2009), which is part of the prior art, discloses a multilayered biodegradable film comprising a core layer comprising a crystalline polylactic acid polymer of 90-100 wt % L-lactic acid units, comprising an ethylene-acrylate copolymer and comprising a heat sealable layer comprising an amorphous polylactic acid polymer having greater than 10 wt % D-lactic acid units and meso-lactide units disposed on one side of the core layer.

Document CN 113 429 754 A (XIONGBITE PACKAGING TECH SUZHOU CO LTD, 24 Sep. 2021), which is part of the prior art, discloses a composite filled fully degradable material composition, characterized in that the composition comprises the following raw materials in parts by weight: PBAT 40-90 parts by weight, PLA 5-20 parts by weight, organic fillers 10-30 parts by weight, inorganic fillers 5-20 parts by weight, plasticizers 1-15 parts by weight, coupling agents 0.3-1 parts by weight, compatible 0.3-1 parts by weight of lubricants, 0.3-1 parts by weight of lubricants, and 0.2-1 parts by weight of compatibilizers and epoxy styrene-acrylic copolymer as compatibilizer.

### SUMMARY OF THE INVENTION

It is an object of the present invention to provide a biodegradable film, with or without an adhesive layer, based on PLA and a method for its production by the method of blown film extrusion (reactive extrusion through a die ring), which film is completely biodegradable without plasticizers, cheap to manufacture, with excellent mechanical and optical properties without limiting the temperature range of application of the products and complying with Directive 94/62/EC of the European Parliament on packaging and packaging waste and the biodegradability standard EN 13432 “Packaging: requirements for packaging recoverable through composting and biodegradation”.

The task of creating a film based on PLA, meeting the above criteria, is achieved by a multilayer biodegradable film according to the combination of features of independent claim 1.

A multilayer biodegradable film may include at least one first layer A and at least one second layer B is provided, where the layer A and layer B are different from each other, where the layer A includes:
i) a minimum of 75 wt. % amorphous polylactic acid (PLA) with D isomer content ≥5%;
ii) triblock epoxy styrene-acrylate copolymer up to 5 wt. % of the total PLA in this layer,

and layer B includes:
i) a minimum of 75 wt. % semi-crystalline polylactic acid (PLA) with a degree of crystallinity ≥20% and low content of D isomer ≤5%, and
ii) triblock epoxy styrene-acrylate copolymer up to 5 wt. % of the total PLA in this layer,

where the epoxy styrene-acrylate triblock copolymer has an average molecular weight of 3000 to 10000, and with the following structural formula:

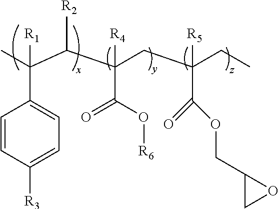

where R₁, R₂, R₃, R₄, R₅ and R₆ are independently from each other methyl, methylene, ethylene or propylene groups.

The epoxy styrene-acrylate triblock copolymer increases the molecular weight of the polylactic acid by reacting with the hydroxyl end groups of the polylactic acid macromolecule and the epoxy group of the triblock copolymer. This increases the melt index and improves the properties of polylactic acid. The resulting film has improved impact strength, tensile strength, and elongation at break while maintaining hardness and thermomechanical resistance at the same time.

In a particularly preferred embodiment, the total molecular weight of the epoxy styrene-acrylate triblock copolymer is about 7100.

In another preferred embodiment, the multilayer biodegradable film further includes a third layer C, which is wholly or partially composed of thermoplastic copolyimide, preferably highly branched polyamide with a low molecular weight of 5,000 to 20,000, and wherein the layers are arranged in the ABC order. The resulting film is a fully transparent biodegradable three-layer film with an adhesive layer included, suitable for hot lamination of paper, aluminum, polyethylene, polyvinyl chloride, polyethylene terephthalate, polyurethane and others.

In another particularly preferred embodiment, the multilayer biodegradable film also includes a third layer C, which is identical to the layer A, wherein the layers are arranged in the ABC order. The resulting film is a fully transparent biodegradable three-layer film of the ABC type, suitable for packaging food and other products by thermal sealing.

In another particularly preferred embodiment, the multilayer biodegradable film is characterised in that the layers A and B further include polyamide from 1 wt. % up to 4 wt. %. The macromolecule of polyamide has hydroxyl end groups, which allows by the same mechanism to react with epoxy styrene-acrylate triblock copolymer, obtaining branched macromolecules with improved properties.

In cases where both components (polylactic acid and polyamide) are present in the mixture at the same time, branched macromolecules with a high molecular weight exceeding twice that of the starting components are obtained. The interaction of the three components occurs during extrusion at temperatures higher than 80° C. or the so-called reactive extrusion. In this way, a new type of branched polymer based on polylactic acid and polyamide is obtained, which has better physico-mechanical properties compared to the initial components. A very important feature of this new material is its ability to compatibilize the polylactic acid and polyamide at molecular level. It is mainly located between the phases of the two components, reducing the surface tension between the different phases. The final products obtained by reactive extrusion have better physico-mechanical properties compared to the initial components, as well as improving the extrusion processes and all other processes related to additional work with the film—treatment, printing, thermal sealing etc.

In a particularly preferred embodiment, the multilayer biodegradable film, when the layers A and B include polyamide, is also characterized in that it includes a third layer C, which is wholly or partially composed of thermoplastic copolyimide, preferably highly branched low molecular weight polyamide with low molecular weight from 5,000 to 20,000, and wherein the layers are arranged in the ABC order. The resulting film is a matte biodegradable three-layer film of the ABC type with an adhesive layer included, suitable for hot lamination of paper, aluminum, polyethylene, polyvinyl chloride, polyethylene terephthalate, polyurethane and others.

In another particularly preferred embodiment, the multilayer biodegradable film, when layers A and B comprise polyamide, is also characterized in that it includes a third layer C, which is identical to the layer A, and where the layers are arranged in the ABC order. The resulting film is a matte biodegradable three-layer film of the ABC type suitable for packaging food and other products by thermal sealing.

In another particularly preferred embodiment, according to any one of the preceding embodiments, the multilayer biodegradable film is characterized by the total thickness of the layers from 5 to 120 microns. The biodegradable film is suitable for laminating paper, cardboard, other films (polyethylene terephthalate, polyethylene, polypropylene, ethylene vinyl acetate, polyamide) or aluminum. The laminating can be done at a temperature between 80 and 120 degrees C. and pressure between 2 and 5 N depending on the thickness of the film. This allows it to be exploited industrially on automatic machines or manual lamination.

In another particularly preferred embodiment, according to any one of the preceding embodiments, the multilayer biodegradable film is characterized in that it is obtained by the method of reactive coextrusion by a blown film die ring. The film produced by this method has extremely good physio-mechanical and optical properties, as well as improved extrusion process and all other processes related to additional work with the film-treatment, printing, thermal sealing, etc., as well as with low cost.

Another object of the present disclosure is to provide a method for manufacturing a multilayer biodegradable film based on PLA by the blown film extrusion, which is achieved by the production of a multilayered biodegradable film based on PLA, in accordance with any one of the previous embodiments of the composition of the multilayered biodegradable film, including the steps:
A) preparing the composition for each of the layers and feeding it to at least two separate extruders A and B, one for each layer A, B, respectively, in a blown extrusion line;
B) melting each layer, wherein the temperature profile of the at least two extruders A, B is positive and increases from 170° C. to 200° C.;
C) the molten composition of the at least two extruders A, B is simultaneously extruded in the form of a bubble by the method of blown extrusion;
D) cooling the extruded bubble with cold air, which maintains the temperature of the bubble not exceeding 70° C. before contact with the nip roller; and
E) rolling, orienting and pulling the resulting bubble of the film.

The main advantage of the film produced by blown extrusion is the better orientation of the macromolecules and the corresponding better mechanical properties. Another important feature is the lower cost of the machine and its lower power consumption.

In a particularly preferred embodiment, the method for producing a multilayer biodegradable film based on PLA by blown extrusion method according to the preceding embodiment, includes the steps:
A) preparing the composition for each of the layers and feeding it into three separate extruders A, B and C, one for each layer A, B, C, respectively, in a blown extrusion line;
B) melting of each layer, wherein the temperature profile of the three extruders A, B, C is positive and increases from 170° C. to 200° C.;
C) the molten composition of the three extruders is simultaneously extruded in the form of a bubble by the method of blown extrusion;
D) cooling the extruded bubble with cold air, which maintains the temperature of the bubble not to exceed 70° C. before its contact with the nip roller;
E) rolling, orienting and pulling the resulting bubble of the film.

In a particularly preferred embodiment, the method for producing a multilayer biodegradable film based on PLA in accordance with the previous embodiment is characterized in that
A) the temperature profile of extruder A is 170° C., 180° C., 190° C., 200° C., 200° C., and the screw speed is 14 min⁻¹, which allows 24 kg/h productivity and 100 bar pressure of the melt;
B) the temperature profile of extruder B is: 170° C., 180° C., 190° C., 200° C., 200° C., and the screw speed is 18 min⁻¹, which allows 45 kg/h productivity and 126 bar pressure on the melt;
C) the temperature profile of extruder C is: 170° C., 180° C., 190° C., 200° C., 200° C.; the screw speed is 12 min⁻¹, which allows 21 kg/h productivity and 60 bar pressure on the melt;
D) all temperatures after the extruders—adapters and die are set at 200° C.; and
E) total productivity 90 kg/h, pull 24 m/min and winding speed 24 m/min.

This method is extremely suitable for the production of matte biodegradable three-layer film of ABC type with an incorporated adhesive layer, suitable for hot lamination of paper, aluminum, polyethylene, polyvinyl chloride, polyethylene terephthalate, polyurethane, etc., as well as for fully transparent biodegradable three-layer film with an incorporated adhesive layer suitable for hot lamination of paper, aluminum, polyethylene, polyvinyl chloride, polyethylene terephthalate, polyurethane, etc.

In another particularly preferred embodiment, the method for producing a multilayer biodegradable film based on PLA, in accordance with the embodiment with the three separate extruders A, B, C, is characterized in that
A) the temperature profile of extruder A is 170° C., 180° C., 190° C., 200° C., 200° C., and the screw speed is 14 min⁻¹, which allows 24 kg/h productivity and 100 bar pressure of the melt;
B) the temperature profile of extruder B is: 170° C., 180° C., 190° C., 200° C., 200° C., and the screw speed is 18 min⁻¹, which allows 45 kg/h productivity and 126 bar pressure on the melt;
C) the temperature profile of extruder C is: 170° C., 18020 C., 190° C., 200° C., 200° C., the screw speed is 14 min⁻¹, which allows 24 kg/h productivity and 100 bar pressure on the melt;
D) all temperatures after the extruders-adapters and die are set at 200° C.; and
E) total productivity 90 kg/h, pull 24 m/min and winding speed 24 m/min.

This method is extremely suitable for the production of matte biodegradable three-layer film of the ABC type suitable for packaging food and other products by thermal sealing, as well as for the production of a fully transparent biodegradable three-layer film of the ABC type suitable for packaging food and other products by thermal sealing.

In each of the described methods, a final step of applying corona treatment to increase the surface tension can be applied.

### BRIEF DESCRIPTION OF THE DRAWINGS

FIG. 1 is a schematic view of a blown extrusion line

FIG. 2 is a schematic view of a three-layer blown extrusion line with a double winding module.

### LIST OF REFERENCE ELEMENTS OF THE FIGS.

1—main motor;
2—reducer;
3—extruder;
4—auger;
5—dispenser(s);
6—adapter;
7—die/nozzle/dye;
8—fan;
9—cooling unit;
10—air ring;
11—film bubble;
12—guides;
13—discharge unit;
14—pulling shafts;
15—flat sleeve;
16—guide shafts;
17—winding device;
18—spool;
19—drive shaft; and
20—rolled film (foil).

### DETAILED DESCRIPTION OF THE INVENTION

Disclosed herewith are detailed embodiments of the present invention. However, it should be understood that the disclosed embodiments are only exemplary for the present invention, which may be implemented in various manufacturing systems. Therefore, specific details disclosed herein should not be construed as limiting.

Plastic films comprising polylactic acid (PLA) and a method for their production by blown film extrusion are described herewith. The terms ‘reactive coextrusion’, ‘blown film die ring reactive coextrusion’, ‘blown extrusion’ should be understood in the same way, namely the die ring extrusion method followed by inflation with a certain volume of air to obtain the required bubble thickness of the film.

In particular, the present invention provides blown films comprising polylactic acid. The use of the terms “film” and “foil” should be interpreted unambiguously and include not only film/foil but also sheets.

Methods for the production of the films (foils) from polylactic acid are also described herewith.

It is accepted in the polymer nomenclature that the name of the polymer sometimes derives from the name of the monomer from which the polymer is made, in other cases, the name of the polymer derives from the name of the smallest repeating unit. For example, the smallest repeating unit in a polylactide is lactic acid. However, the commercial polylactide is produced by polymerizing lactide, which is a lactic acid dimer.

Since both lactic acid and lactide can achieve the same repeating unit, the general terms “polylactic acid”, “polylactide” and “PLA” as used here, refer to polymers that have a repeating unit (Structural formulas A, B and C) without any restriction on how the polymer is synthesized (e.g. from lactides, lactic acid and/or their oligomers) and without reference to the degree of polymerization. Also, the terms are intended to include in their scope both polymers based on lactic acid and polymers based on polylactide, the terms being used interchangeably. Namely, the terms “polylactic acid”, “polylactide” and “PLA” are not limiting as to how the polymer is formed.

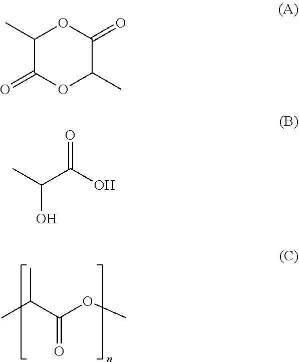

Structural formulas: (A) Polylactic acid (Polylactide), (B) Lactic acid, (C) Lactide

The term “comprises” used in the embodiments and claims should not be construed as limiting to the content mentioned there, but it should be borne in mind that other components may be present in the composition, such as pigments, dyes, antioxidants, UV stabilizers, colorants or plasticizers, which may also be added if necessary.

By foil type A, B, C is to be construed a three-layer foil (film), wherein layer B is to be understood as the middle layer and layers A and C as the two outer layers. Respectively, film of type A, B should be understood as a two-layer foil (film).

Similarly, in the film production method, extruders A, B and/or C should be understood as extruders in which the extrusion of each layer A, B and/or C, respectively, takes place.

In the embodiments below two types of polylactic acid are used: Ingeo™ Biopolymer 4032D brand amorphous polylactic acid (PLA) with D isomer content ≥5%, and Ingeo™ Biopolymer 4060D brand semi-crystalline PLA with crystallinity ≥20% and low D isomer content ≤5% respectively, purchased from NatureWorks LLC of Minnetonka, Minnesota.

Ingeo™ Biopolymer 4032D brand PLA has the following characteristics: molecular weight M_{w}=202,000 g/mol; melting temperature Tₘ=170° C.; glass transition temperature T_{g}=55° C.; melt index MFI=7 g/10 min; modulus of elasticity 60 MPa; elongation at break 6%.

Ingeo™ Biopolymer 4060D brand semi-crystalline PLA has the following characteristics: molecular weight M_{w}=107,000 g/mol; melting temperature Tₘ=160° C.; glass transition temperature T_{g}=55-60° C.; melt index MFI=9 g/10 min; modulus of elasticity 64 MPa; elongation at break 3.6%.

The polyamide is Ultramid® C37LC brand copolyamide, which has the following characteristics: melting point—Tₘ=181° C. and MFI=6.5 g/10 min, purchased from BASF SE of Ludwigshafen, Germany.

The triblock epoxy styrene-acrylate copolymer is Joncryl® ADR 4400 brand copolymer, which has the following characteristics: molecular weight 7100 g/mol, glass transition temperature T_{g}=65° C., an epoxy group equivalent 485 g/mol, purchased from BASF SE of Ludwigshafen, Germany.

The thermoplastic copolyamide is Platamid® M1276 brand copolyamide, which has the following characteristics: melting point—Tₘ=160° C. and MFI=6 g/10 min, purchased from Arkema Group of Colombes, France.

The illustrated examples relate to a three-layer biodegradable film, which the inventors have found to have the best physico-mechanical and optical properties and the best cost.

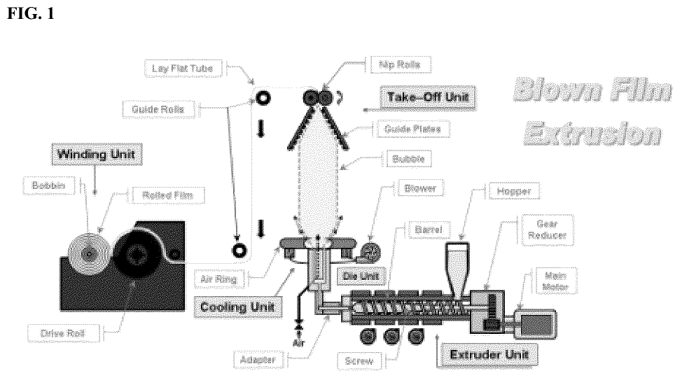

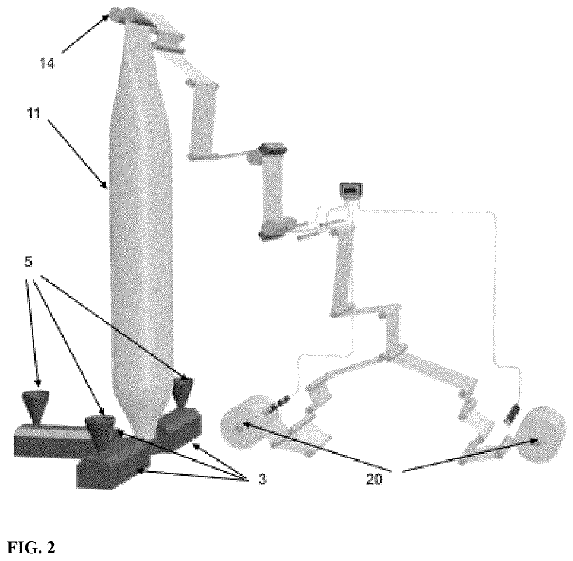

Referring to FIGS. 1-2, both the two-layer and the three-layer film are produced on a blown film extrusion line. As shown in FIG. 1, the blown extrusion line includes main motor 1, reducer 2, extruder 3, auger 4, dispenser(s) 5, adapter 6, die/nozzle 7, fan 8, cooling unit 9, air ring 10, film bubble 11, guides 12, a discharge block 13, pulling shafts 14, a flat sleeve 15, guide shafts 16, a winding device 17 including a spool 18 and a guide shaft 19 through which the wound film passes 20.

In both methods for obtaining a two-layer or three-layer film, the line is equipped with three separate extruders each with 4 dispensers, only 2 of them are used for the two-layer film and all 3 extruders for the three-layer film, respectively. The molten plastic from the two or three extruders (depending on the type of foil—two-layer or three-layer) are fed simultaneously in a special die for blown extrusion, in this case, a die ring. The film comes out uniformly from the die, inflated with compressed air like a bubble and cooled with cold air. After the formation of the bubble, the film passes through several shafts, which orient and pull it. The film takes the shape of a sleeve, which is split with vertical knives to obtain a single-layer film (FIG. 2). The thus obtained single-layer film is wound on two different spools.

To obtain the biodegradable two-layer or three-layer film according to the present invention, the standard Windmöller & Hölscher line for three-layer blown co-extrusion of polyethylene with a die ring of 200 mm and a die width to bubble diameter ratio of 1:2.5 is used. The film is type AB and ABC, extruded in 2 or 3 layers, respectively, each in a separate extruder, which is equipped with 4 automatic gravimetric dosing systems. After the formation of the bubble, the film is cooled with cold air, which keeps the temperature of the film under 70° C. before its contact with the nip roller. The inflated bubble is rolled, oriented and pulled until the film is obtained. The resulting film is a three-layer film with a width of 900 cm and a thickness of 25 microns. The dynamometer strength indicators are determined on a ZWICK 1464 dynamometer according to the BDS EN ISO 527-1:2020 standard “Plastics: Determination of tensile properties”.

Although the production of the multilayer biodegradable film according to the present disclosure is particularly recommended, efficient and cost-effective, it will be apparent to the person skilled in the art that the multilayer biodegradable film according to the present disclosure can also be obtained by direct flat die extrusion with subsequent rolling with cooled polished shafts and the present invention is not limited to its production by a blown extrusion.

The invention is illustrated by the following non-limiting examples:

### Example 1—Matte Biodegradable Two-Layer Film of the AB Type Without an Adhesive Layer, Suitable for Packaging Food and Other Products by Thermal Sealing

The raw materials in layer A are the following:
Ingeo™ Biopolymer 4060D brand semi-crystalline PLA—94.25% of the whole layer;
Ultramid® C37LC brand copolyamide—4.0% of the whole layer;
Joncryl® ADR 4400 brand copolymer—1.75% of the whole layer.
The temperature profile of extruder A is as follows: 170° C., 180° C., 190° C., 200° C., 200° C. The screw speed is 16 min⁻¹, which provides 30 kg/h productivity and 100 bar melt pressure.

The raw materials in layer B are the following:
Ingeo™ Biopolymer 4032D brand PLA—94.25% of the whole layer;
Ultramid® C37LC brand copolyamide—4.0% of the whole layer;
Joncryl® ADR 4400 brand copolymer—1.75% of the whole layer.
The temperature profile of extruder B is as follows: 170° C., 180° C., 190° C., 200° C., 200° C. The screw speed is 22 min⁻¹, which provides 60 kg/h productivity and 126 bar melt pressure.

All temperatures after the extruders—adapters and die are set at 200° C.

The parameters of the blown extrusion line are: total productivity 90 kg/h, pull speed 24 m/min and winding speed 24 m/min. To obtain a film with a thickness of 7 microns, the parameters are: total productivity is 90 kg/h, pull speed 80 m/min and winding speed 80 m/min. To obtain a film with a thickness of 100 microns, the parameters are: total productivity 250 kg/h, pull speed 30 m/min and winding speed 30 m/min.

With these parameters, the foil allows it to be wound with a strength of 40N, without defects on single-layer rolls of the desired size and thickness. The surface tension of the foil is 38 dyn, if desired it can be treated with a corona discharge, in which the surface tension is 42 dyn. The film obtained in this way has the following physico-mechanical properties:

By Machine Direction (MD):
Tensile strength—65 MPa
Elongation at break—30%

By Transverse Direction (TD):
Tensile strength—55 MPa
Elongation at break—10%

Opacity coefficient:
4.6 according to the EN ISO 13468-1:2019 standard, “Plastics: Determination of the total luminous transmittance of transparent materials”
   Example 2—Matte Biodegradable Three-Layer Film of Type ABC with an Adhesive Layer, Suitable for Hot Lamination for Paper, Aluminum, Polyethylene, Polyvinyl Chloride, Polyethylene Terephthalate, Polyurethane and Others

The raw materials in layer A are the following:
Ingeo™ Biopolymer 4060D brand semi-crystalline PLA—94.25% of the whole layer;
Ultramid® C37LC brand copolyamide—4.0% of the whole layer;
Joncryl® ADR 4400 brand copolymer—1.75% of the whole layer.
The temperature profile of extruder A is as follows: 170° C., 180° C., 190° C., 200° C., 200° C. The screw speed is 14 min⁻¹, which provides 24 kg/h productivity and 100 bar melt pressure.

The raw materials in layer B are the following:
Ingeo™ Biopolymer 4032D brand PLA—94.25% of the whole layer;
Ultramid® C37LC brand copolyamide—4.0% of the whole layer;
Joncryl® ADR 4400 brand copolymer—1.75% of the whole layer.
The temperature profile of extruder B is as follows: 170°° C., 18° C., 190° C., 200° C., 200° C. The screw speed is 18 min⁻¹, which provides 45 kg/h productivity and 126 bar melt pressure.

The raw materials in layer C are the following:
Platamid® M1276 brand copolyamide—100%
The temperature profile of extruder C is as follows: 170° C., 180° C., 190° C., 200° C., 200° C. The screw speed is 12 min⁻¹, which provides 21 kg/h productivity and 60 bar melt pressure.

All temperatures after the extruders—adapters and die are set at 200° C.

The parameters of the blown extrusion line are: total productivity 90 kg/h, pull speed 24 m/min and winding speed 24 m/min. To obtain foil with a thickness of 7 microns, the parameters are: total productivity is 90 kg/h, pull speed 80 m/min. and winding speed 80 m/min. To obtain a film with a thickness of 100 microns, the parameters are: total productivity 250 kg/h, pull speed 30 m/min. and winding speed 30 m/min.

With these parameters, the foil allows it to be wound with a strength of 40N, without defects on single-layer rolls of the desired size and thickness. The surface tension of the foil is 38 dyn, if desired it can be treated with a corona discharge, in which the surface tension is 42 dyn. The film obtained in this way has the following physico-mechanical properties:

By machine direction (MD):
Tensile strength—65 MPa
Elongation at break—30%

By Transverse direction (TD):
Tensile strength—55 MPa
Elongation at break—10%

Opacity coefficient:
4.6 according to EN ISO 13468-1:2019

### Example 3—Matte Biodegradable Three-Layer Film of Type ABC Suitable for Packaging Food and Other Products by Thermal Sealing

The raw materials in layer A are the following:
Ingeo™ Biopolymer 4060D brand semi-crystalline PLA—94.25% of the whole layer;
Ultramid® C37LC brand copolyamide—4.0% of the whole layer;
Joncryl® ADR 4400 brand copolymer—1.75% of the whole layer.
The temperature profile of extruder A is as follows: 170° C., 180° C., 190° C., 200° C., 200° C. The screw speed is 14 min⁻¹, which provides 24 kg/h productivity and 100 bar melt pressure.

The raw materials in layer B are the following:
Ingeo™ Biopolymer 4032D brand PLA—94.25% of the whole layer;
Ultramid® C37LC brand copolyamide—4.0% of the whole layer;
Joncryl® ADR 4400 brand copolymer—1.75% of the whole layer.
The temperature profile of extruder B is as follows: 170° C., 180° C., 190° C., 200° C., 200° C. The screw speed is 18 min⁻¹, which provides 45 kg/h productivity and 126 bar melt pressure.

The raw materials in layer C are the following:
Ingeo™ Biopolymer 4060D brand semi-crystalline PLA—94.25% of the whole layer;
Ultramid® C37LC brand copolyamide—4.0% of the whole layer;
Joncryl® ADR 4400 brand copolymer—1.75% of the whole layer.
The temperature profile of extruder A is as follows: 170° C., 180° C., 190° C., 200° C., 200° C. The screw speed is 14 min⁻¹, which provides 24 kg/h productivity and 100 bar melt pressure.

All temperatures after the extruders—adapters and die are set at 200° C.

The parameters of the blown extrusion line are: total productivity 90 kg/h, pull speed 24 m/min and winding speed 24 m/min. To obtain a film with a thickness of 7 microns, the parameters are: total productivity is 90 kg/h, pull speed 80 m/min. and winding speed 80 m/min. To obtain a film with a thickness of 100 microns, the parameters are: total productivity 250 kg/h, pull speed 30 m/min. and winding speed 30 m/min.

With these parameters, the film allows it to be wound with a strength of 40N, without defects on single-layer rolls of the desired size and thickness. The surface tension of the film is 38 dyn, if desired it can be treated with a corona discharge, in which the surface tension is 42 dyn. The film obtained in this way has the following physico-mechanical properties:

By Machine direction (MD):
Tensile strength—45 MPa
Elongation at break—30%

By Transverse direction (TD):
Tensile strength—35 MPa
Elongation at break—10%

Opacity coefficient:
4.6 according to EN ISO 13468-1:2019

### Example 4−Transparent Biodegradable Three-Layer Film of Type ABC Suitable for Packaging Food and Other Products by Thermal Sealing

The raw materials in layer A are the following:
Ingeo™ Biopolymer 4060D brand semi-crystalline PLA—98.25% of the whole layer;
Joncryl® ADR 4400 brand copolymer—1.75% of the whole layer.
The temperature profile of extruder A is as follows: 170° C., 180° C., 190° C., 200° C., 200° C. The screw speed is 14 min⁻¹, which provides 24 kg/h productivity and 100 bar melt pressure.

The raw materials in layer B are the following:
Ingeo™ Biopolymer 4032D brand PLA—98.25% of the whole layer;
Joncryl® ADR 4400 brand copolymer—1.75% of the whole layer.
The temperature profile of extruder B is as follows: 170° C., 180° C., 190° C., 200° C., 200°° C. The screw speed is 18 min⁻¹, which provides 45 kg/h productivity and 126 bar melt pressure.

The raw materials in layer C are the following:
Ingeo™ Biopolymer 4060D brand semi-crystalline PLA—98.25% of the whole layer;
Joncryl® ADR 4400 brand copolymer—1.75% of the whole layer.
The temperature profile of extruder A is as follows: 170° C., 180° C., 190° C., 200° C., 200° C. The screw speed is 14 min⁻¹, which provides 24 kg/h productivity and 100 bar melt pressure. All temperatures after the extruders-adapters and die are set at 200° C.

The parameters of the blown extrusion line are: total productivity 90 kg/h, pull speed 24 m/min and winding speed 24 m/min. To obtain a film with a thickness of 7 microns, the parameters are: total productivity is 90 kg/h, pull speed 80 m/min. and winding speed 80 m/min. To obtain a film with a thickness of 100 microns, the parameters are: total productivity 250 kg/h, pull speed 30 m/min. and winding speed 30 m/min.

With these parameters, the film allows it to be wound with a strength of 40N, without defects on single-layer rolls of the desired size and thickness. The surface tension of the foil film is 38 dyn, if desired it can be treated with a corona discharge, in which the surface tension is 42 dyn. The film obtained in this way has the following physico-mechanical properties:

By Machine direction (MD):
Tensile strength—30 MPa
Elongation at break—15%

By Transverse direction (TD):
Tensile strength—20 MPa
Elongation at break—5%

### Example 5—Transparent Biodegradable Two-Layer Film of Type AB Without Adhesive Layer, Suitable for Packaging Food and Other Products by Thermal Sealing

The raw materials in layer A are the following:
Ingeo™ Biopolymer 4060D brand semi-crystalline PLA—98.25% of the whole layer;
Joncryl® ADR 4400 brand copolymer—1.75% of the whole layer.
The temperature profile of extruder A is as follows: 170° C., 180° C., 190° C., 200° C., 200° C. The screw speed is 16 min⁻¹, which provides 30 kg/h productivity and 100 bar melt pressure.

The raw materials in layer B are the following:
Ingeo™ Biopolymer 4032D brand PLA—98.25% of the whole layer;
Joncryl® ADR 4400 brand copolymer—1.75% of the whole layer.
The temperature profile of extruder B is as follows: 170° C., 180° C., 190° C., 200° C., 200° C. The screw speed is 22 min⁻¹, which provides 60 kg/h productivity and 126 bar melt pressure.

The parameters of the blown extrusion line are: total productivity 90 kg/h, pull speed 24 m/min and winding speed 24 m/min. To obtain a film with a thickness of 7 microns, the parameters are: total productivity is 90 kg/h, pull speed 80 m/min. and winding speed 80 m/min. To obtain a film with a thickness of 100 microns, the parameters are: total productivity 250 kg/h, pull speed 30 m/min and winding speed 30 m/min.

With these parameters, the film allows it to be wound with a strength of 40N, without defects on single-layer rolls of the desired size and thickness. The surface tension of the film is 38 dyn, if desired it can be treated with a corona discharge, in which the surface tension is 42 dyn. The film obtained in this way has the following physical and mechanical properties:

By Machine direction (MD):
Tensile strength—55 MPa
Elongation at break—25%

By Transverse direction (TD):
Tensile strength—40 MPa
Elongation at break—10%
   Example 6—Transparent Biodegradable Three-Layer Film with an Adhesive Layer, Suitable for Hot Lamination for Paper, Aluminum, Polyethylene, Polyvinyl Chloride, Polyethylene Terephthalate, Polyurethane and Others

The raw materials in layer A are the following:
Ingeo™ Biopolymer 4060D brand semi-crystalline PLA—98.25% of the whole layer;
Joncryl® ADR 4400 brand copolymer—1.75% of the whole layer.
The temperature profile of extruder A is as follows: 170° C., 180° C., 190° C., 200° C., 200° C. The screw speed is 14 min⁻¹, which provides 24 kg/h productivity and 100 bar melt pressure.

The raw materials in layer B are the following:
Ingeo™ Biopolymer 4032D brand PLA—98.25% of the whole layer;
Joncryl® ADR 4400 brand copolymer—1.75% of the whole layer.
The temperature profile of extruder B is as follows: 170° C., 180° C., 190° C., 200° C., 200° C. The screw speed is 18 min⁻¹, which provides 45 kg/h productivity and 126 bar melt pressure.

The raw materials in layer C are the following:
Platamid® M1276 brand copolyamide—100%
The temperature profile of extruder C is as follows: 170° C., 180° C., 190° C., 200° C., 200° C. The screw speed is 12 min⁻¹, which provides 21 kg/h productivity and 60 bar melt pressure. All temperatures after the extruders—adapters and die are set at 200° C.

The parameters of the blown extrusion line are: total productivity 90 kg/h, pull speed 24 m/min and winding speed 24 m/min. To obtain a film with a thickness of 7 microns, the parameters are: total productivity is 90 kg/h, pull speed 80 m/min. and winding speed 80 m/min. To obtain a film with a thickness of 100 microns, the parameters are: total productivity 250 kg/h, pull speed 30 m/min and winding speed 30 m/min.

With these parameters, the film allows it to be wound with a strength of 40N, without defects on single-layer rolls of the desired size and thickness. The surface tension of the film is 38 dyn, if desired it can be treated with a corona discharge, in which the surface tension is 42 dyn. The film obtained in this way has the following physical and mechanical properties:

By Machine direction (MD):
Tensile strength—55 MPa
Elongation at break—25%

By Transverse direction (TD):
Tensile strength—40 MPa
Elongation at break—10%

The films and the compounds disclosed herewith ensure environmentally friendly materials, as their physical destruction and degradation are faster and more complete than conventional non-degradable plastics, which they can replace (e.g. polyethylene, polypropylene, etc.). That is, the intermediate products from the degradation, lactic acid and its short polymers, are common naturally occurring substances that are easily metabolized by a wide variety of organisms to carbon dioxide and water. Thus, PLA-based films are a desirable substitute for many conventional plastic films. Such applications include, but are not limited to, batteries, boxes, bottles, disposable lighters, pens and decorative items, food boxes with windows (e.g., pastries, donuts), food coatings (e.g., packaging and bags covering meat, fish and vegetables), toys, flower bags and envelopes.

The films of the present invention were tested according to ASTM D 6866:2020-02, “Standard Test Methods for Determining the Biobased Content of Solid, Liquid, and Gaseous Samples Using Radiocarbon Analysis,” and the following parameters were established:
Biobased carbon footprint content: 92%
Organic matter: 100%

The films of the present invention may be particularly suitable for packaging food of any type. The components used for the production of this film have certificates for contact with food products. The tests have shown that there is no migration of chemicals from the film to food. In the test performed by test method VLM 104:2010 under test conditions: HPLC/MS/MS, 10 days, 40° C., model solution B, the values illustrated in Table 1 were obtained:

TABLE 1

| Parameter | Unit | Test Result, Uncertainty | Method of Analyses | Test conditions |
|---|---|---|---|---|
| Primary amines in plastic | | | VLM 104:2010 | HPLC/MS/MS, 10 days, |
| | | | | 40° C., simulant B |
| p-Phenylenediamine (p-PDA) | μg/kg | <2.0 | | |
| m-Phenylenediamine (m-PDA) | μg/kg | <2.0 | | |
| 2,6-Toluenediamine (2,6-TDA) | μg/kg | <2.0 | | |
| 4-Methoxy-m-phenylenediamine | μg/kg | <2.0 | | |
| (4-M-mPDA) | | | | |
| 2,4-Toluenediamine (2,4-TDA) | μg/kg | <2.0 | | |
| Aniline (ANL) | μg/kg | <2.0 | | |
| o-Anisidine (o-ASD) | μg/kg | <2.0 | | |
| o-Toluidine (o-T) | μg/kg | <2.0 | | |
| Benzidine (BNZ) | μg/kg | <2.0 | | |
| 4-Chloro-aniline (4-CA) | μg/kg | <2.0 | | |
| 4,4-Diaminodiphenylether (4,4-DPE) | μg/kg | <2.0 | | |
| 4,4-Methylenedianiline (4,4-MDA) | μg/kg | <2.0 | | |
| 2,6-Dimethylaniline (2,6-DMA) | μg/kg | <2.0 | | |
| 2-Methoxy-5-methylaniline (2-M-5-MA) | μg/kg | <2.0 | | |
| 2,4-Dimethylaniline (2,4-DMA) | μg/kg | <2.0 | | |
| 4-Chloro-o-toluidine (4-CoT) | μg/kg | <2.0 | | |
| 3,3-Dimethylbenzidinee (3,3-DMB) | μg/kg | <2.0 | | |
| 4,4-Methylenedi-o-toluidine (4,4-MDoT) | μg/kg | <2.0 | | |
| 2,4,5-Trimethylaniline (2,4,5-TMA) | μg/kg | <2.0 | | |
| 4-Aminobiphenyl (4-ABP) | μg/kg | <2.0 | | |

<Limit of quantification (LOQ)
* Limit of detection (LOD)

The PLA-based films of the present invention can also be used in applications that traditionally use paper, such as envelopes and plaques.

The films of the present invention may be particularly suitable for print applications. In fact, the relatively high surface tension of PLA films makes them susceptible to (printed) ink, often without additional surface treatment. For example, the surface energy of substantially pure polylactide films of the present invention is from 38 up to 42 dyn. This results in a surface with satisfactory printable characteristics without surface modification. In this way, inks that are generally more difficult to apply to films, such as water-based inks, can be applied directly to PLA films.

The films, printed or otherwise, can also be produced with glue on one side to provide pressure-sensitive labels. These labels can be applied to various consumer products, such as bottles (e.g. drinks, shampoos, tubes, cans, etc.) and general packaging.

It should also be apparent from the disclosure herewith that the PLA-based films according to this invention are not limited to one size. That is, the thickness and width of the films according to the invention can be adjusted according to well-known and used techniques and the necessities of the end customer. For example, the extrusion speed can be adjusted to determine the thickness of the product. The pull speed is the speed at which the bubble is withdrawn through a nozzle or die; usually the higher the speed, the thinner the thickness.

It may be desirable to adjust the film thickness to suit a particular application.

Pigments, dyes, colorants, plasticizers and other additives may also be added if necessary.

1. A multilayer biodegradable film comprising at least one first layer A and at least one second layer B, wherein layer A and layer B are different from each other, characterized in that layer A comprises:
i) a minimum of 75 wt. % amorphous polylactic acid with a D isomer content ≥5%;
ii) triblock epoxy styrene-acrylate copolymer up to 5 wt. % of the total polylactic acid in this layer,
and layer B comprises:
i) a minimum of 75 wt. % semi-crystalline polylactic acid with a degree of crystallinity ≥20% and a low D isomer content ≤5%;
ii) triblock epoxy styrene-acrylate copolymer up to 5 wt. % of the total polylactic acid in this layer,
wherein the triblock epoxy styrene-acrylate copolymer has an average molecular weight of 3000 to 10000 and with the following structural formula: 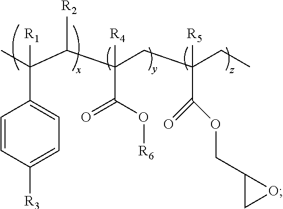
wherein R₁, R₂, R₃, R₄, R₅ and R₆ are independent from each other methyl, methylene, ethylene or propylene groups.

2. The multilayer biodegradable film according to claim 1, characterized in that the triblock epoxy styrene-acrylate copolymer has an average molecular weight of about 7100.

3. The multilayer biodegradable film according to claim 1, characterized in that it also comprises a third layer C, which is wholly or partially composed of thermoplastic copolyamide, preferably highly branched polyamide with a low molecular weight of 5,000 to 20,000 and wherein the layers are arranged in the ABC order.

4. The multilayer biodegradable film according to claim 1, characterized in that it also comprises a third layer C, which is identical to the layer A, and wherein the layers are arranged in the ABC order.

5. The multilayer biodegradable film according to claim 1, characterized in that the layers A and B further comprise polyamide from 1 to 4% by weight.

6. The multilayer biodegradable film according to claim 5, characterized in that it also comprises a third layer C, which is wholly or partially composed of thermoplastic copolyamide, preferably highly branched polyamide with a low molecular weight of 5,000 to 20,000, and wherein the layers are arranged in the ABC order.

7. The multilayer biodegradable film according to claim 5, characterized in that it also comprises a third layer C, which is identical to the layer A, and where the layers are arranged in the ABC order.

8. The multilayer biodegradable film according to claim 1, characterized in that it has a total layer thickness of 5 to 120 microns.

9. The multilayer biodegradable film according to claim 1, characterized in that it is obtained by the method of reactive coextrusion by a die ring.

10. A method for producing a multilayer biodegradable film based on polylactic acid according to claim 1 for a multilayer biodegradable film composition, comprising the steps of:
A) preparing the composition for each of the layers and feeding it to at least two separate extruders A and B, one for each layer A, B, respectively, in a blown extrusion line;
B) melting each layer, wherein the temperature profile of at least two extruders A, B being positive and increasing from 170° C. to 200° C.;
C) the molten composition of the at least two extruders A, B is simultaneously extruded in the form of a bubble by the method of blown film extrusion;
D) cooling the extruded bubble with cold air, which maintains the temperature of the bubble not to exceed 70° C. before its contact with the nip roller;
E) rolling, orienting and pulling the resulting bubble from the film.

11. The method for producing a multilayer biodegradable film based on polylactic acid according to claim 10, comprising the steps of:
A) preparing the composition for each of the layers and feeding it into three separate extruders A, B and C, one for each layer A, B, C, respectively, in a blown film extrusion line;
B) melting of each layer, such as the temperature profile of the three extruders A, B, C is positive and increases from 170° C. to 200° C.;
C) the molten composition of the three extruders is simultaneously extruded in the form of a bubble by the method of blown film extrusion;
D) cooling the extruded bubble with cold air, which maintains the temperature of the bubble not to exceed 70° C. before its contact with the nip roller;
E) rolling, orienting and pulling the resulting bubble from the film;

12. The method for producing a multilayer biodegradable film based on polylactic acid according to claim 11, characterized in that
A) the temperature profile of extruder A is 170° C., 180° C., 190° C., 200° C., 200° C., and the screw speed is 14 min⁻¹, which provides 24 kg/h productivity and 100 bar melt pressure;
B) the temperature profile of extruder B is: 170° C., 180° C., 190° C., 200° C., 200° C., and the screw speed is 18 min⁻¹, which provides 45 kg/h productivity and 126 bar melt pressure;
C) the temperature profile of extruder C is: 170° C., 180° C., 190° C., 200° C., 200° C., the screw speed is 12 min⁻¹, which provides 21 kg/h productivity and 60 bar melt pressure;
D) all temperatures after the extruders—adapters and die are set at 200° C.;
E) total productivity 90 kg/h, withdrawal 24 m/min and winding speed 24 m/min.

13. The method for producing a multilayer biodegradable film based on polylactic acid according to claim 11, characterized in that
A) the temperature profile of extruder A is 170° C., 180° C., 190° C., 200° C., 200° C., and the screw speed is 14 min⁻¹, which provides 24 kg/h productivity and 100 bar melt pressure;
B) the temperature profile of extruder B is: 170° C., 180° C., 190° C., 200° C., 200° C., and the screw speed is 18 min⁻¹, which provides 45 kg/h productivity and 126 bar melt pressure;
C) the temperature profile of extruder C is: 170° C., 180° C., 190° C., 200° C., 200° C., the screw speed is 14 min⁻¹, which provides 24 kg/h productivity and 100 bar melt pressure;
D) all temperatures after the extruders—adapters and die are set at 200° C.;
E) total productivity 90 kg/h, withdrawal 24 m/min and winding speed 24 m/min.
